(19) United States
(12) Patent Application Publication
(10) Pub. No.: US 2018/0039940 A1
(43) Pub. Date: Feb. 8, 2018

(54) ENVIRONMENTAL PARAMETER MONITOR WITH WIDE AREA COMMUNICATION

(71) Applicant: Carrier Corporation, Farmington, CT (US)

(72) Inventor: Stephen Varga, Bedford, NH (US)

(21) Appl. No.: 15/537,009

(22) PCT Filed: Dec. 16, 2015
(86) PCT No.: PCT/US2015/066039

§ 371 Date: Jun. 16, 2017

Related U.S. Application Data
(60) Provisional application No. 62/092,367, filed on Dec. 16, 2014.

(51) Int. Cl. G06Q 10/08; F25D 29/00

(52) U.S. Cl. CPC G06Q 10/0832; F25D 29/003; F25D 29/008; F25D 2700/12; F25D 2700/00; H04L 12/2854

(57) ABSTRACT

A method and system for cold chain monitoring of perishable goods, includes at least one environmental sensor to monitor at least one environmental parameter, a wide area network interface to communicate with a wide area network, a controller to log a plurality of readings from each of the at least one environmental sensors and to transmit at least one data signal associated with the plurality of readings to the wide area network via the wide area network interface.

### FIELD OF THE INVENTION

The subject matter disclosed herein relates to environmental parameter monitoring, and to a system and a method for monitoring environmental parameters via a wide area network.

### DESCRIPTION OF RELATED ART

Typically, cold chain distribution systems are used to transport and distribute temperature sensitive and perishable goods. For example, food and pharmaceuticals may be susceptible to temperature, humidity, and other environmental factors. Advantageously, cold chain systems allow perishable and environmentally sensitive goods to be effectively transported and distributed without damage or other undesirable effects.

Environmental parameter sensors are often used in cold chain distribution systems to monitor the conditions and integrity of the cold chain and consequently the goods transported. Current environmental parameter sensing systems may log data to be retrieved at a later time, but may not prevent damage or other undesirable effects from occurring to goods in transit. A system and method that can provide real time monitoring of environmental parameters via a wide area network is desired.

### BRIEF SUMMARY

According to an embodiment of the invention, an apparatus for cold chain monitoring of perishable goods, includes at least one environmental sensor to monitor at least one environmental parameter, a wide area network interface to communicate with a wide area network, a controller to log a plurality of readings from each of the at least one environmental sensors and to transmit at least one data signal associated with the plurality of readings to the wide area network via the wide area network interface.

In addition to one or more of the features described above, or as an alternative, further embodiments could include that the at least one data signal includes at least one of: the plurality of readings from each of the at least one environmental sensors and an excursion alarm signal associated with the plurality of readings from each of the at least one environmental sensors.

In addition to one or more of the features described above, or as an alternative, further embodiments could include that the wide area network interface is a cellular interface to communicate with a cellular network.

In addition to one or more of the features described above, or as an alternative, further embodiments could include that the apparatus is associated with a transportation operation.

In addition to one or more of the features described above, or as an alternative, further embodiments could include that a rerouting, transferring or storage operation is associated with the at least one data signal.

In addition to one or more of the features described above, or as an alternative, further embodiments could include a short range interface, wherein the short range interface includes at least one of: a wired interface, an optical interface, and a short range wireless interface.

In addition to one or more of the features described above, or as an alternative, further embodiments could include that the plurality of readings from each of the at least one environmental sensors is transferred via a secondary download.

In addition to one or more of the features described above, or as an alternative, further embodiments could include that the perishable goods includes at least one of food and pharmaceuticals.

According to an embodiment of the invention, a method for cold chain monitoring of perishable goods, includes providing at least one environmental sensor, monitoring at least one environmental parameter via the at least one environmental sensor, logging a plurality of readings from each of the at least one environmental sensors via a controller, and transmitting at least one data signal associated with the plurality of readings to a wide area network via a wide area network interface.

In addition to one or more of the features described above, or as an alternative, further embodiments could include that the at least one data signal is a group including of at least one of: the plurality of readings from each of the at least one environmental sensors and an excursion alarm signal associated with the plurality of readings from each of the at least one environmental sensors.

In addition to one or more of the features described above, or as an alternative, further embodiments could include that the wide area network interface is a cellular interface to communicate with a cellular network.

In addition to one or more of the features described above, or as an alternative, further embodiments could include transporting the perishable goods.

In addition to one or more of the features described above, or as an alternative, further embodiments could include includes rerouting, transferring or storing the perishable goods in response to the at least one data signal.

In addition to one or more of the features described above, or as an alternative, further embodiments could include transmitting the plurality of readings via a short range interface, wherein the short range interface includes at least one of: a wired interface, an optical interface, and a short range wireless interface.

In addition to one or more of the features described above, or as an alternative, further embodiments could include transferring the plurality of readings from each of the at least one environmental sensors via a secondary download.

Technical function of the embodiments described above includes a wide area network interface to communicate with a wide area network, and a controller to log a plurality of readings and transmit at least one data signal associated with the plurality of readings.

Other aspects, features, and techniques of the invention will become more apparent from the following description taken in conjunction with the drawings.

### BRIEF DESCRIPTION OF THE SEVERAL VIEWS OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which like elements are numbered alike in the several FIGURES:

FIG. 1 illustrates a schematic view of an exemplary cold chain distribution system suitable for use with an embodiment of the invention;

FIG. 2 is a schematic view of an exemplary environmental parameter monitor in accordance with an embodiment of the invention; and

FIG. 3 is a flow diagram of a method of monitoring environmental parameters in accordance with an embodiment of the invention.

### DETAILED DESCRIPTION OF THE INVENTION

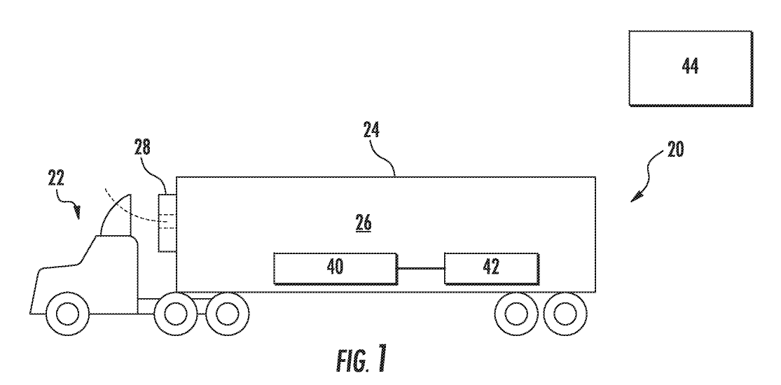

Referring now to the drawings, FIG. 1 illustrates a schematic view of an exemplary cold chain transportation or distribution system suitable for use with an environmental parameter monitor. In an exemplary embodiment, cold chain transportation system 20 includes an environmentally controlled container 24, cargo 40, logging device 42, and wide area network 44. The container 24 may be pulled by a tractor 22. It is understood that embodiments described herein may be applied to shipping containers that are shipped by rail, sea, or any other suitable container, without use of a tractor 22. The container 24 may define an interior compartment 26.

In an exemplary embodiment, environmental control system 28 is associated with container 24 to provide desired environmental parameters, such as temperature, humidity, CO₂ level, and other conditions to the interior compartment 26. In certain embodiments, environmental control system 28 is a refrigeration system capable of providing a desired temperature and humidity range. In an exemplary embodiment, cargo 40 is associated with an environmental monitor 42 subjected to the same environment as the cargo 40. In an exemplary embodiment, cargo 40 includes food, drugs, or any other suitable cargo requiring cold chain transport. The environmental monitor 42 may be placed in a variety of locations within interior compartment 26, including directly on the cargo 40.

In an exemplary embodiment, environmental monitor 42 monitors parameters and communicates with a wide area network 44.

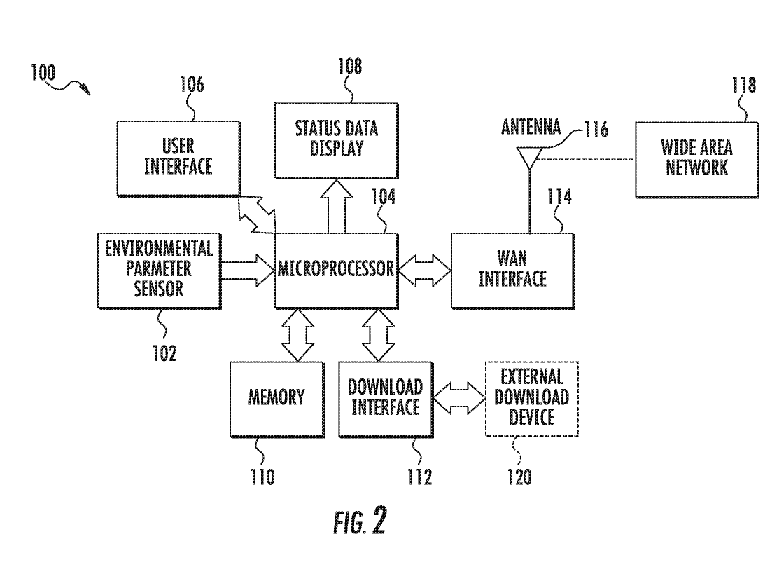

FIG. 2 shows an exemplary architecture of an environmental monitor 100. In an exemplary embodiment, environmental monitor 100 includes at least one environmental parameter sensor 102, a controller 104 (e.g., a microprocessor), and a wide area network interface 114. Environmental monitor 100 may be used in cold chain operations and transportation as described in FIG. 1.

In an exemplary embodiment, at least one sensor 102 is utilized to monitor environmental parameters and generate a sensor reading. Environmental parameters may include position data, humidity, time, temperature, shock, vibration, ambient light, and gas emissions (such as carbon dioxide and ethylene). Accordingly, suitable sensors 102 are utilized to monitor the desired parameters. Advantageously, sensors 102 may be selected for certain applications depending on the cargo to be monitored and the corresponding environmental sensitivities. In an exemplary embodiment, temperatures are monitored. In certain embodiments, a user desires to maintain and monitor temperatures or other parameters within an acceptable range.

In an exemplary embodiment, readings from sensors 102 are received and processed by the controller 104. In an exemplary embodiment, readings from sensors 102 are received and logged in memory 110 during a desired monitoring period. In certain embodiments, the readings are further augmented with time, position stamps or other relevant information. Data logged in memory 110 may include a reading from sensor 102, whether the reading exceeds (a high or low) limit placed for a corresponding parameter, the sensed time and/or the sensed location.

The inclusion of controller 104 allows further analysis to be performed. In certain embodiments, controller 104 is programmed with or accepts predetermined ranges or limits for corresponding sensors. If a sensor 102 reading exceeds (a high or low) limit placed for a corresponding parameter, the time, place, and the sensor reading may be recorded. In certain embodiments, an alarm signal is stored, displayed, and/or transmitted via wide area network interface 114.

In certain embodiments, the data recorded to memory 110 is authenticated to prevent tampering of environmental data. The data in memory 110 may be signed, encrypted or otherwise authenticated. Advantageously, such authentication ensures the recorded data is accurate and allows an accurate assessment of recorded environmental conditions.

In an exemplary embodiment, controller 104 communicates with a wide area network 118 via a wide area network interface 114. Wide area network 118 and wide area network interface 114 may be any suitable network, including, but not limited to cellular networks, satellite communication networks, private wide area networks, etc. In certain embodiments, wide area network interface 114 communicates with intermediate or base stations to communicate with wide area network 118. In certain embodiments, communication distances are state wide, country wide, or international. In an exemplary embodiment, wireless transmissions are sent and received via antenna 116. Data transmitted via wide area network 118 may be transmitted to a central monitoring location, to a shipper, a receiver, or any other suitable location. Antenna 116 may be integral to monitor 100 or external to monitor 100. In certain embodiments, antenna 116 is associated with the cargo container or transporter.

Advantageously, wide area network transmissions of logged data or the analyzed data (including, but not limited to alarm and excursion data) described above allows for real time monitoring of the relevant environmental parameters. In an exemplary embodiment, a responsible party can monitor the sensors 102, any parameter excursions beyond predefined limits, and any alarm conditions. Additionally, a responsible party may monitor additional parameters not internally monitored by monitor 100. In certain embodiments, the responsible party can make real time decisions about the cargo to avoid or minimize undesirable effects. In response to monitored parameters or an event of interest, such as a climate control failure or malfunction, a responsible party can provide instructions and decisions. Such decisions can include communication with a truck driver/transportation provider, preemptively rejecting goods, reporting a parameter excursion to a third party, and/or rerouting cargo to an environmentally controlled storage facility.

In an exemplary embodiment, environmental monitor 100 includes a user interface 106 and status data display 108 to allow a user to directly and locally interact with data logger 100. In an exemplary embodiment, environmental monitor 100 can display status information and relevant data points on display 108. In certain embodiments, user interface 106 allows a user to stop and start monitoring operations, as well as review data and alarm conditions. Advantageously, a local use and review of environmental monitor 100 can allow on-site review and determinations to be made regarding routing, storage and goods acceptance.

In an exemplary embodiment, a local interface 112 facilitates a secondary data download after the cargo has reached a checkpoint or a destination. Data may be transferred to an external download device 120. The locally downloaded data may be authenticated, provide additional data for diagnostic purposes or provide data in accordance with receiver/shipper protocols. The local interface 112 may transfer data by any suitable local method, including, but not limited to USB, serial transmission, optical transmission, local Wi-Fi, personal area networks, or any other suitable local interface.

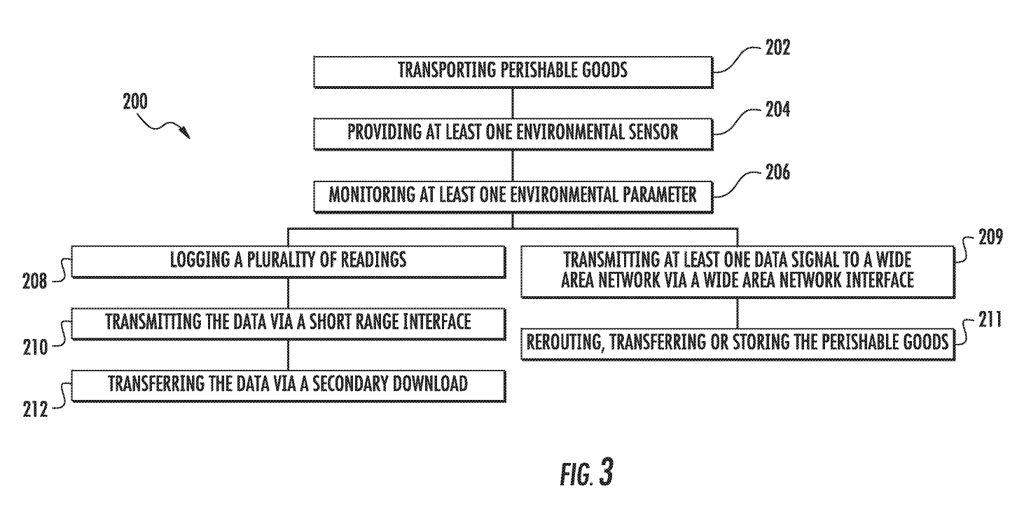

FIG. 3 illustrates an exemplary method 200 to monitor environmental parameters, particularly in a cold chain system. In operation 202, environmentally sensitive cargo, including perishable food and pharmaceuticals are transported via a suitable cold chain transport.

In operation 204 a suitable environmental monitor 100 is placed to be associated with the environmentally sensitive cargo to monitor the environmental parameters the cargo is subjected to.

In operation 206, the parameters are monitored by the controller 104. Monitoring operations may sample at any frequency desired depending on cargo sensitivity requirements and technical requirements. The controller may include predefined parameter limits to determine alarm conditions in case of parameter excursion.

In operation 208, the readings from sensors 102 are logged in memory 110 for later review. Data logged in memory 110 may include sensor readings, time, position, alarms, and any other suitable information.

In operation 210 the data logged in memory 110 can be locally transmitted via a local interface 112. Such a transmission may occur when the cargo arrives at a checkpoint or destination.

In operation 212 the locally transferred data are transferred via a secondary download device (e.g., imported to a personal computer, tablet, etc.). The downloaded data may be reviewed for parameter excursions, abnormalities, and other suitable metrics. Such a secondary download may be authenticated to prevent tampering.

In addition to logging data as described in operation 208, data may be transmitted in operation 209. In operation 209 data associated with the parameters is transmitted via a wide area network. Data may include logged readings, time, position, alarms, and any other suitable information.

The operations in FIG. 3 may be performed in various orders. In exemplary embodiments, data is logged at operation 208 and then sent via a local interface at operation 210, as shown. In other exemplary embodiments, data could be logged at operation 208 and then sent via wide area network interface at operation 209. In other exemplary embodiments, data is sent via wide area network interface at operation 209. Thus, embodiments are not limited to the order of operations in exemplary FIG. 3.

In operation 211, the data transmitted may be actively monitored by a responsible party. In response to data transmitted, the transportation device may be rerouted, transferred or stored to prevent or mitigate undesired effects.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions or equivalent arrangement not hereto described will be apparent to those of ordinary skill in the art without departing from the scope and spirit of the invention. Additionally, while the various embodiments of the invention have been described, it is to be understood that aspects of the invention may include only some of the described embodiments. Accordingly, the invention is not to be seen as limited by the foregoing description, but is only limited by the scope of the appended claims.

1. An apparatus for cold chain monitoring of perishable goods, comprising:
at least one environmental sensor to monitor at least one environmental parameter; a wide area network interface to communicate with a wide area network; and
a controller to log a plurality of readings from each of the at least one environmental sensors and to transmit at least one data signal associated with the plurality of readings to the wide area network via the wide area network interface.

2. The apparatus of claim 1, wherein the at least one data signal includes at least one of: the plurality of readings from each of the at least one environmental sensors and an excursion alarm signal associated with the plurality of readings from each of the at least one environmental sensors.

3. The apparatus of claim 1, wherein the wide area network interface is a cellular interface to communicate with a cellular network.

4. The apparatus of claim 1, wherein the apparatus is associated with a transportation operation.

5. The apparatus of claim 1, wherein a rerouting, transferring or storage operation is associated with the at least one data signal.

6. The apparatus of claim 1, further comprising a short range interface, wherein the short range interface includes at least one of: a wired interface, an optical interface, and a short range wireless interface.

7. The apparatus of claim 1, wherein the plurality of readings from each of the at least one environmental sensors is transferred via a secondary download.

8. The apparatus of claim 1, wherein the perishable goods include at least one of food and pharmaceuticals.

9. A method for cold chain monitoring of perishable goods, comprising:
providing at least one environmental sensor;
monitoring at least one environmental parameter via the at least one environmental sensor;
logging a plurality of readings from each of the at least one environmental sensors via a controller; and
transmitting at least one data signal associated with the plurality of readings to a wide area network via a wide area network interface.

10. The method of claim 9, wherein the at least one data signal includes at least one of: the plurality of readings from each of the at least one environmental sensors and an excursion alarm signal associated with the plurality of readings from each of the at least one environmental sensors.

11. The method of claim 9, wherein the wide area network interface is a cellular interface to communicate with a cellular network.

12. The method of claim 9, further comprising transporting the perishable goods.

13. The method of claim 9, further comprising rerouting, transferring or storing the perishable goods in response to the at least one data signal.

14. The method of claim 9, further comprising transmitting the plurality of readings via a short range interface, wherein the short range interface includes at least one of: a wired interface, an optical interface, and a short range wireless interface.

15. The method of claim 9, further comprising transferring the plurality of readings from each of the at least one environmental sensors via a secondary download.
